(19) United States
(12) Patent Application Publication
(10) Pub. No.: US 2011/0067741 A1
(43) Pub. Date: Mar. 24, 2011

(54) PORTABLE CONTAINMENT UNIT

(76) Inventors: Scott DeLeo, Andover, MA (US); John Pierson, Lawrence, MA (US)

(21) Appl. No.: 12/784,194

(22) Filed: May 20, 2010

Related U.S. Application Data
(60) Provisional application No. 61/179,989, filed on May 20, 2009.

(51) Int. Cl. E04H 15/06; B62B 3/02; E04H 15/34; E04H 15/32

(52) U.S. Cl. 135/96; 280/79.11; 135/121; 135/120.3

(57) ABSTRACT

A portable containment unit including an enclosure, a base supporting the enclosure, the base having wheels attached thereto for moving the containment unit, an extension platform selectively coupled to the base and having wheels attached thereto, and an air machine on the extension platform. The containment unit may also include an auxiliary portion selectively coupled to the base for providing support to additional items, wherein the auxiliary portion is designed to be stored under the base. The enclosure may include a frame, a resilient tarp attached to the frame, and a portion that can be selectively opened. A shroud surrounds the portion that can be opened. The shroud includes an edge connector for coupling the portable containment unit to another portable containment unit. The enclosure can include a transparent portion.

### CROSS-REFERENCE TO RELATED APPLICATION

This application claims priority to U.S. Provisional Patent Application No. 61/179,989 filed May 20, 2009, which is incorporated herein by reference.

### BACKGROUND OF THE DISCLOSURE

1. Field of the Disclosure

The subject disclosure relates to containment units, and more particularly to an improved containment unit that can be easily assembled, modified, and moved to a desired location.

2. Background of the Related Art

Shelters are used to contain debris. An example is illustrated in U.S. Pat. No. 4,682,448 entitled SHELTER and issued on Jul. 28, 1987 to Brian J. Healey, which is incorporated herein by reference.

### SUMMARY OF THE INVENTION

In a preferred embodiment, the subject technology is directed to a portable containment unit including an enclosure, a base supporting the enclosure, the base having wheels attached thereto for moving the containment unit, an extension platform selectively coupled to the base and having wheels attached thereto, and an air machine on the extension platform. The containment unit may also include an auxiliary portion selectively coupled to the base for providing support to additional items, wherein the auxiliary portion may be designed to be stored under the base.

The enclosure may include a frame, a resilient tarp attached to the frame, and a portion that can be selectively opened. A shroud surrounds the portion that can be opened. The shroud includes an edge connector for coupling the portable containment unit to another portable containment unit. The enclosure can include a transparent portion.

It should be appreciated that the present technology can be implemented and utilized in numerous ways, including without limitation as a process, an apparatus, a system, a device, a method for applications now known and later developed. These and other unique features of the system disclosed herein will become more readily apparent from the following and attached description and the accompanying drawings.

### BRIEF DESCRIPTION OF THE DRAWINGS

So that those having ordinary skill in the art to which the disclosed system appertains will more readily understand how to make and use the same, reference may be had to the following drawings.

FIG. 1 is a perspective view of a containment unit with side access panels open in accordance with the subject technology.

FIG. 2 is a perspective view of a containment unit with side access panels closed in accordance with the subject technology.

FIG. 3 is a perspective view of a containment unit in a collapsed condition in accordance with the subject technology.

FIG. 4 is a perspective view of an extension platform of a base for a containment unit in accordance with the subject technology.

### DETAILED DESCRIPTION OF PREFERRED EMBODIMENTS

The present disclosure overcomes many of the prior art problems associated with containment units. The advantages, and other features of the system disclosed herein, will become more readily apparent to those having ordinary skill in the art from the attached description of certain preferred embodiments taken in conjunction with the drawings which set forth representative embodiments of the present invention.

Unless otherwise specified, the illustrated embodiments can be understood as providing exemplary features of varying detail of certain embodiments, and therefore, unless otherwise specified, features, components, modules, elements, and/or aspects of the illustrations can be otherwise combined, interconnected, sequenced, separated, interchanged, positioned, and/or rearranged without materially departing from the disclosed systems or methods. Additionally, the shapes and sizes of components are also exemplary and unless otherwise specified, can be altered without materially affecting or limiting the disclosed technology.

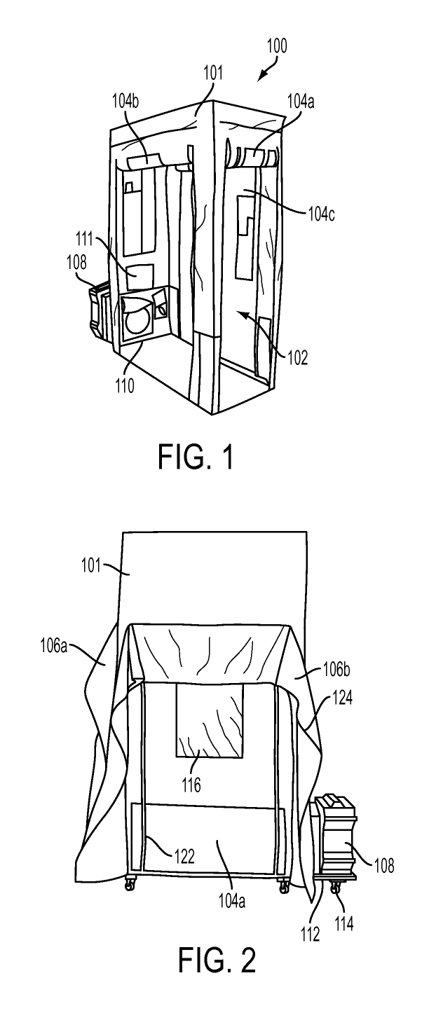

Referring to FIGS. 1 and 2, perspective views of a containment unit 100 in an open and closed position are shown. The containment unit 100 is mobile and provides isolation from the surrounding environment. The isolation is created by establishing a pressure differential environment within an interior 102 of the containment unit. Although typically a negative pressure environment in the interior 102, the environment may also be one of positive pressure to keep contamination out of the interior 102 depending upon the application. The containment unit 100 is easily assembled and disassembled. Typical uses, without limitation, of the containment unit 100 are in hospital for patient isolation to control airborne particulate and pathogens, to contain dust and debris during renovations, construction, and repair, for facilities maintenance, and as as anteroom for infection control or maintenance/facilities area. The containment unit 100 may also serve as an anteroom to a larger room or area.

The containment unit 100 has an enclosure 101 with access panels 104a-c, each surrounded by a detachable shroud 106a-c as well as a ceiling access panel (not explicitly shown) surrounded by a detachable shroud. The shrouds 106a-c may attach to the enclosure 101 or the panels 104a-c. Panel 104b opposes panel 104c so that even after assembly, a patient may be rolled through the containment unit 100, when used, for example, as an anteroom. Preferably, the enclosure 101 is fabricated from a fire resistant material. The ceiling and side access panels 104a, 104b allow using the containment unit 100 for ceiling work such as changing a light bulb, cabling and HVAC access as well as side wall work such as plumbing, power and communication equipment related work.

The panels 104a-c and shrouds 106a-c may zipper together or use hook/loop fabric strips and the like to create the necessary openings. As shown, the panels 104a-c include a zipper 122 for opening and closing. The shrouds 106a-c also include edge zippers 124 or hook/loop fabric so that multiple containment units 100 may be joined together rather than just sealingly fixed to a stationary wall or ceiling. In one embodiment, additional fabric is gathered at the upper portion of the enclosure 101 so that even upon deployment at less than maximum height, the panels 104a-c would still operate effectively. The gathering devices could be hook/loop fabric, snaps, ties, zippers and the like.

Preferably, the panel 104a is sized to match a standard door opening and the panel 104b is sized to match a standard double door opening. However, even if non-standard, the respective shrouds 106a, 106b are configured to accommodate mismatched sizes. The height of the enclosure 101 is adjustable up to or beyond standard ceiling height to create an effective engagement with the ceiling. The enclosure 101 also has an integral window 116 and/or pass through portal with a screen (not shown explicitly).

To create the negative pressure environment, the containment unit 100 includes an air machine 108. The air machine 108 couples to the interior 102 by a port 110 to pull air from or push air into the interior 102 as the case may be. Typically air is pulled so that the interior 102 becomes a negative pressure environment. Preferably, the air machine 108 is configured to filter the air as well such that undesirable contaminants such as airborn pathogens, asbestos dust and the like are collected for proper, safe disposal. A pressure relief panel 111 may be selectively opened to allow access to the air machine 108 from the interior 102 without exiting and/or to reduce the negative/positive pressure in the interior 102.

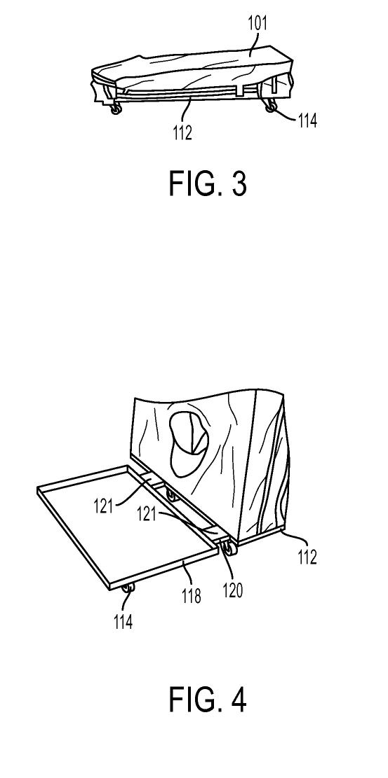

A base 112 supports the enclosure 101 and air machine 108 with HEPA filtration. Hence, the enclosure 101 and air machine 108 can be moved together. The base 112 is preferably 30 inches wide in order to be easily moved through doorways. The base 112 is fabricated from aluminum or similar rigid material. The enclosure 101 also collapses as shown in FIG. 3 to allow easy movement on locking wheels 114 attached to the base 112. Alternatively, the enclosure 101 may be removed from the base 112. Further, the wheels 114 may be removed from the base 112 and an edge of the base beveled so that other items may be easily rolled through or into the containment unit 100 such as when used as an anteroom.

Referring to FIG. 4, the base 112 includes an extension base platform 118 with a locking mechanism 120 for supporting the air machine 108. The removable extension platform 118 allows decoupling the air machine 108 and moving the air machine 108 separately. Additionally, the extension platform 118 can accommodate alternative air machines, other equipment, tools, supplies and the like. The locking mechanism 120 includes two forks 121 that slide within channels (not explicitly shown) on the underside of the base 112. A plurality of holes (not shown explicitly) in the forks 121 and base 112 allow fixing the extension platform 118 at a plurality of positions with respect to the base 112 with a pin, screw or the like.

As can be seen, the containment unit 100 offers control of dust and airborne particles, reduces labor costs, reduces the risks of infection, eliminates the need for disposable barriers, improves job site aesthetics, suppresses noise, and reduces volatile organic compounds among other benefits.

While the invention has been described with respect to preferred embodiments, those skilled in the art will readily appreciate that various changes and/or modifications can be made to the invention without departing from the spirit or scope of the invention.

1. A portable containment unit comprising:
an enclosure;
a base supporting the enclosure, the base having wheels attached thereto for moving the containment unit;
an extension platform selectively coupled to the base and having wheels attached thereto; and
an air machine on the extension platform.

2. A portable containment unit as recited in claim 1, further comprising an auxiliary portion selectively coupled to the base for providing support to additional items.

3. A portable containment unit as recited in claim 2, wherein the auxiliary portion is designed to be stored under the base.

4. A portable containment unit as recited in claim 1, wherein the enclosure includes a frame and a resilient tarp attached to the frame.

5. A portable containment unit as recited in claim 1, wherein the enclosure includes a first portion that can be selectively opened.

6. A portable containment unit as recited in claim 5, further comprising a shroud surrounding the first portion.

7. A portable containment unit as recited in claim 6, wherein the shroud includes an edge connector for coupling the portable containment unit to another portable containment unit.

8. A portable containment unit as recited in claim 5, wherein the enclosure includes a second portion that can be selectively opened opposing the first portion.

9. A portable containment unit as recited in claim 1, further comprising a locking mechanism for selectively coupling the extension platform to the base at a plurality of different positions.

10. A portable containment unit as recited in claim 9, wherein the base includes two channels and the locking mechanism includes two forks that slide within the channels.

11. A portable containment unit as recited in claim 10, wherein the base and forks define a plurality of holes and further comprising two pins to fix the extension platform at a position with respect to the base.

12. A portable containment unit as recited in claim 1, wherein the enclosure includes a transparent portion.

13. A portable containment unit as recited in claim 1, wherein the enclosure includes a pressure relief panel selectively openable to allow access to the air machine from within the enclosure.

14. A portable containment unit as recited in claim 1, wherein the wheels are removable from the base and an edge of the base is beveled.

15. A portable containment unit as recited in claim 1, further comprising gathering fixtures attached to the enclosure for collecting additional enclosure fabric at an upper portion thereof.

16. A multi-stage containment unit comprising:
a) a first enclosure including: a portion that can be selectively opened; a shroud surrounding the portion; a edge connector on the shroud; and a base supporting the enclosure, the base having wheels attached thereto for moving the first enclosure; and
b) a second enclosure including: a portion that can be selectively opened; a shroud surrounding the portion; and an edge connector on the shroud,
wherein the edge connectors engage to couple the first and second enclosures and create a multi-stage differential pressure environment therein.

17. A multi-stage containment unit as recited in claim 16, further comprising an extension platform selectively coupled to the base and having wheels attached thereto and an air machine on the extension platform.
